(19) United States
(12) Patent Application Publication
(10) Pub. No.: US 2005/0196624 A1
(43) Pub. Date: Sep. 8, 2005

(54) Acrylic resin

(75) Inventors: Akira Kawamura, Osaka (JP); Ryu Takeko, Ashiya-shi (JP); Tomo Iwata, Niihama-shi (JP)

Correspondence Address: BIRCH STEWART KOLASCH & BIRCH, PO BOX 747, FALLS CHURCH, VA, 22040-0747, US

(73) Assignee: Sumitomo Chemical Company, Limited, Tokyo (JP)

(21) Appl. No.: 11/062,604

(22) Filed: Feb. 22, 2005

(30) Foreign Application Priority Data
Feb. 25, 2004 (JP) 2004-049201

(51) Int. Cl. B32B 17/10; C08K 3/20

(52) U.S. Cl. 428/441; 428/442; 524/457

(57) ABSTRACT

An acrylic resin obtained by copolymerizing the following (a), (b), (c) and (d):
(a): a (meth)acrylate of the formula (1), 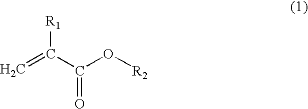
(b): a monomer containing at least two (meth)acryloyl groups of the general formula (2) in the molecule, 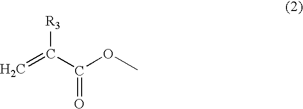 (c): a monomer containing a heterocycle and one olefinic double bond in the molecule, and (d): a monomer different from (a), (b) and (c), and containing one olefinic double bond and at least one polar functional group selected from the group consisting of a carboxyl group, hydroxyl group, amide group, amino group, epoxy group, aldehyde group and isocyanate group in the molecule.

### BACKGROUND OF THE INVENTION

1. Technical Field of the Invention

The present invention relates to an acrylic resin.

2. Description of the Related Art

Liquid crystal cells generally used in liquid crystal displays such as a TN liquid crystal cell (TFT), a STN liquid crystal cell (STN) and the like, have a structure in which a liquid crystal component is sandwiched between two glass base materials. On the surface of the glass base material, an optical film such as a polarizing film, a phase retardation film and the like is laminated via an adhesive composed mainly of an acrylic resin. An optical laminate composed of a glass base material, an adhesive and an optical film laminated in this order is in general produced by a method in which first an optical laminated film having an adhesive layer composed of an adhesive laminated on an optical film is produced, subsequently, a glass base material is laminated on the surface of the adhesive layer.

Such an optical laminated film tends to generate curl and the like due to large dimension change by expansion and shrinkage under heating or moistening and heating conditions, consequently, there are problems such as occurrence of foaming in an adhesive layer of the resulted optical laminate, generation of peeling between an adhesive layer and a glass base material, and the like. Under heating or moistening and heating conditions, distribution of remaining stress acting on an optical laminated film becomes non-uniform, concentration of stress occurs around peripheral parts of an optical laminate, consequently, there is a problem that light leakage occurs in a TN liquid crystal cell (TFT). For solving such problems, there is a suggestion on an adhesive mainly composed of an acrylic resin having a structural unit derived from N-vinylpyrrolidone which is a kind of monomer having a hetero-cycle in the molecule (Japanese Patent Application Laid-Open (JP-A) No. 5-107410).

However, there is a problem that, when a liquid crystal cell obtained by using an optical laminate having an adhesive layer made of an adhesive mainly composed of an acrylic resin having a structural unit derived from N-vinylpyrrolidone is preserved under moistening and heating conditions, light leakage occurs.

### DISCLOSURE OF THE INVENTION

An object of the present invention is to provide an acrylic resin capable of producing an optical laminated film used in a liquid crystal cell in which light leakage is suppressed.

The present inventors have intensively studied to find an acrylic resin capable of solving problems as described above, and resultantly found that an acrylic resin containing a structural unit derived from a monomer containing at least two (meth)acryloyl groups in the molecule manifests, when a liquid crystal cell is produced, little light leakage, and have completed the present invention.

Namely, the present invention provides the following [1] to [9].

[1] An acrylic resin obtained by copolymerizing the following (a), (b), (c) and (d):
(a): a (meth)acrylate of the formula (1) 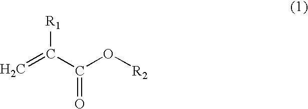
   (wherein, R₁ represents a hydrogen atom or methyl group, R₂ represents an alkyl group having 1 to 14 carbon atoms or an aralkyl group having 1 to 14 carbon atoms, and a hydrogen atom in the alkyl group R₂ or a hydrogen atom in the aralkyl group R₂ may be substituted with an alkoxy group having 1 to 10 carbon atoms),
(b): a monomer containing at least two (meth)acryloyl groups of the general formula (2) in the molecule 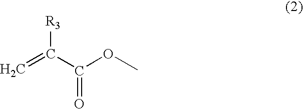
   (wherein, R₃ represents a hydrogen atom or methyl group),
(c): a monomer containing a heterocycle and one olefinic double bond in the molecule, and
(d): a monomer different from (a), (b) and (c), and containing one olefinic double bond and at least one polar functional group selected from the group consisting of a carboxyl group, hydroxyl group, amide group, amino group, epoxy group, aldehyde group and isocyanate group in the molecule.

[2] The acrylic resin according to [1], wherein the monomer (c) is at least one monomer selected from the group consisting of N-vinylpyrrolidone, acryloylmorpholine and vinylcaprolactam.

[3] An adhesive comprising the acrylic resin according to [1] or [2], and a cross-linking agent and/or silane-based compound.

[4] An optical laminated film having the adhesive according to [3] laminated on both surfaces or one surface of an optical film.

[5] The optical laminated film according to [4], wherein the optical film is a polarizing film and/or phase retardation film.

[6] The optical laminated film according to [4] or [5], wherein the optical film is an optical film further having an acetylcellulose-based film as a protective film.

The optical laminated film according to any of [4] to [6], wherein a release film is further laminated on the adhesive layer of the optical laminated film.

[8] An optical laminate obtained by laminating a glass base material on the adhesive layer of the optical laminated film according to any of [4] to [6].

[9] An optical laminate obtained by peeling the release film from the optical laminated film according to [7], then, laminating a glass base material on the adhesive layer of the optical laminated film.

The present invention will be described in detail below.

The acrylic resin of the present invention can be obtained by copolymerizing the above-mentioned (a), (b), (c) and (d).

The monomer (a) used in the present invention is a (meth)acrylate of the formula (1):

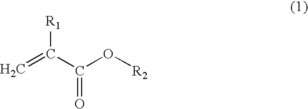

Wherein, R₁ represents a hydrogen atom or methyl group, and R₂ represents an alkyl group having 1 to 14 carbon atoms or an aralkyl group having 1 to 14 carbon atoms. A hydrogen atom in the alkyl group R₂ or a hydrogen atom in the aralkyl group R₂ may be substituted with an alkoxy group having 1 to 10 carbon atoms.

Examples of the alkyl group having 1 to 14 carbon atoms include a methyl group, ethyl group, butyl group, octyl group and the like.

Examples of the aralkyl group having 1 to 14 carbon atoms include a benzyl group and the like.

Examples of the alkoxy group having 1 to 10 carbon atoms include a methoxy group, ethoxy group, butoxy group and the like.

Examples of the monomer (a) include acrylates such as methyl acrylate, ethyl acrylate, propyl acrylate, n-butyl acrylate, iso-butyl acrylate, 2-ethylhexyl acrylate, n-octyl acrylate, iso-octyl acrylate, lauryl acrylate, stearyl acrylate, cyclohexyl acrylate, benzyl acrylate, methoxyethyl acrylate and ethoxylmethyl acrylate and the like; and methacrylates such as methyl methacrylate, ethyl methacrylate, propyl methacrylate, n-butyl methacrylate, iso-butyl methacrylate, 2-ethylhexyl methacrylate, n-octyl methacrylate, iso-octyl methacrylate, lauryl methacrylate, stearyl methacrylate, cyclohexyl methacrylate, benzyl methacrylate, methoxyethyl methacrylate, ethoxymethyl methacrylate and the like.

The monomer (b) used in the present invention is a monomer having at least two (meth)acryloyl groups of the formula (2) in the molecule.

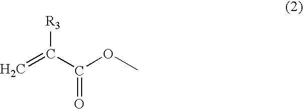

In the formula, R₃ represents a hydrogen atom or methyl group.

Examples of the monomer (b) include monomers having two (meth)acryloyl groups in the molecule such as 1,4-butanediol di(meth)acrylate, 1,6-hexanediol di(meth)acrylate, 1,9-nonanediol di(meth)acrylate, ethylene glycol di(meth)acrylate, diethylene glycol di(meth)acrylate, tetraethylene glycol di(meth)acrylate, tripropylene glycol di(meth)acrylate and the like; monomers having three (meth)acryloyl groups such as trimethylolpropane tri(meth)acrylate and the like.

The monomer (b) may be used in combination of two or more.

Among monomers (b), monomers having two (meth)acryloyl groups in the molecule are preferably used.

The monomer (c) is a monomer containing a heterocycle having at least one hetero atom such as a nitrogen atom, oxygen atom, sulfur atom and the like, and one olefinic double bond in the molecule.

The heterocycle is preferably a 5 to 12-membered ring containing a hetero atom, and examples thereof include heterocycles containing a nitrogen atom such as a pyrrolidine ring, imidazolidine ring, piperazine rind, piperidine ring, pyrrolidone ring, morpholine ring, caprolactam ring, quinuclidine ring and the like; hetero rings containing an oxygen atom such as a lactone ring, tetrahydrofuran ring, dioxane ring and the like.

Examples of the monomer (c) include monomers containing a heterocycle having a nitrogen atom, and one olefinic double bond in the molecule such as acryloylmorpholine, N-vinyl-2-pyrrolidone, vinylcaprolactam, caprolactone-modified tetrahydrofurfuryl acrylate, and the like; monomers containing a heterocycle having an oxygen atom, and one olefinic double bond in the molecule such as tetrahydrofurfuryl acrylate, tetrahydrofurfuryl methacrylate, and the like.

The monomer (c) may be used in combination of two or more.

Among the monomers (c), monomers containing a 5 to 12-membered ring having a nitrogen atom, and one olefinic double bond in the molecule are preferably used, and particularly, N-vinyl-2-pyrrolidone, vinylcaprolactam and acryloylmorpholine are preferably used.

The monomer (d) is a monomer different from (a), (b) and (c), and containing at least one polar functional group selected from the group consisting of a carboxyl group, hydroxyl group, amino group, amide group, epoxy group, aldehyde group and isocyanate group, and one olefinic double bond in the molecule.

Specifically, examples of the monomer (d) in which the polar functional group is a carboxyl group include α,β-unsaturated carboxylic acids such as acrylic acid, methacrylic acid, maleic acid, itaconic acid and the like.

Examples of the monomer (d) in which the polar functional group is a hydroxyl group include hydroxyalkyl α,β-unsaturated carboxylates such as 2-hydroxyethyl (meth)acrylate, 2-hydroxypropyl (meth) acrylate, 4-hydroxybutyl (meth)acrylate and the like.

Examples of the monomer (d) in which the polar functional group is an amino group include N,N-dimethylaminoethyl acrylate, allylamine and the like.

Examples of the monomer (d) in which the polar functional group is an amide group include acrylamide, methacrylamide, N,N-dimethylaminopropylacrylamide, diacetonediamide, N,N-dimethylacrylamide, N,N-diethylacrylamide, N-methylolacrylamide and the like.

Examples of the monomer (d) in which the polar functional group is an epoxy group include glycidyl acrylate, glycidyl methacrylate and the like.

Examples of the monomer (d) in which the polar functional group is an aldehyde group include acrylaldehyde and the like.

Examples of the monomer (d) in which the polar functional group is an isocyanate group include 2-methacryloyloxyethyl isocyanate and the like.

The monomer (d) may be used in combination of two or more.

Among them, α,β-unsaturated carboxylic acids and hydroxyalkyl α,β-unsaturated carboxylates are preferably used as the monomer (d), and more preferably used are acrylic acid, methacrylic acid, 2-hydroxyethyl (meth)acrylate, 2-hydroxypropyl (meth)acrylate and 4-hydroxybutyl (meth)acrylate, and further preferably used are 2-hydroxyethyl (meth)acrylate, 2-hydroxypropyl (meth)acrylate and 4-hydroxybutyl (meth)acrylate.

The content of a structural unit derived from the monomer (a) is usually from about 45 to 99.84 parts by weight, preferably from about 70 to 99 parts by weight based on 100 parts by weight of an acrylic resin (solid content).

The content of a structural unit derived from the monomer (b) is usually from 0.01 to 5 parts by weight, preferably from about 0.1 to 3 parts by weight based on 100 parts by weight of an acrylic resin (solid content). When the content of a structural unit derived from the monomer (b) is 0.01 part by weight or more, cohesive force of the resulting resin tends to be improved preferably, and when 5 parts by weight or less, generation of a gel in producing a resin tends to be suppressed preferably.

The content of a structural unit derived from the monomer (c) is usually from about 0.1 to 30 parts by weight, preferably from about 0.1 to 20 parts by weight based on 100 parts by weight of an acrylic resin (solid content). When the content of the monomer (b) is 0.1 part by weight or more, an effect of improving a light leakage occurring in processing a liquid crystal panel tends to be improved preferably, and when 30 parts by weight or less, peeling between an adhesive layer and a glass base material tends to be suppressed preferably.

The content of a structural unit derived from the monomer (d) is usually from about 0.05 to 20 parts by weight, preferably from about 0.1 to 15 parts by weight based on 100 parts by weight of an acrylic resin (solid content). When the content of the structural unit (d) is 0.05 parts by weight or more, cohesive force of the resulting resin tends to be improved preferably, and when 20 parts by weight or less, peeling between an adhesive layer and a glass base material tends to be suppressed preferably.

The acrylic resin of the present invention can also be obtained by copolymerizing the monomers (a) to (d), and additionally, a vinyl-based monomer different from any of the monomers (a) to (d).

Examples of the vinyl-based monomer include fatty vinyl esters, halogenated vinyls, halogenated vinylidenes, aromatic vinyls, (meth)acrylonitrile, conjugated diene compounds and the like.

Examples of the fatty vinyl ester include vinyl acetate, vinyl propionate, vinyl butyrate, vinyl 2-ethylhexanoate, vinyl laurate and the like.

Examples of the halogenated vinyl include vinyl chloride, vinyl bromide and the like.

Examples of the halogenated vinylidene include vinylidene chloride and the like.

The aromatic vinyl is a compound having a vinyl group and an aromatic group, and specific examples thereof include styrene-based monomers such as styrene, methylstyrene, dimethylstyrene, trimethylstyrene, ethylstyrene, diethylstyrene, triethylstyrene, propylstyrene, butylstyrene, hexylstyrene, heptylstyrene, octylstyrene, fluorostyrene, chlorostyrene, bromostyrene, dibromostyrene, iodostyrene, nitrostyrene, acetylstyrene, methoxystyrene, divinylbenzene and the like, nitrogen-containing aromatic vinyls such as vinylpyridine, vinyl carbazole and the like.

Examples of the (meth)acrylonitrile include acrylonitril, methacrylonitrile and the like.

The conjugated diene compound is an olefin containing a conjugated double bond in the molecule, and specific examples thereof include isoprene, butadiene, chloroprene and the like.

As the method of producing an acrylic resin of the present invention, for example, a solution polymerization method, emulsion polymerization method, block polymerization method, suspension polymerization method and the like are listed.

In production of an acrylic resin, a polymerization initiator is usually used. The polymerization initiator is used in an amount of about 0.001 to 5 parts by weight based on 100 parts by weight of the total weight of the monomers (a) to (d).

As the polymerization initiator, a heat-polymerization initiator, photo-polymerization initiator, and the like are exemplified.

Examples of the photo-polymerization initiator include 4-(2-hydroxyethoxyphenyl) and the like.

Examples of the heat-polymerization initiator include azo-based compounds such as 2,2′-azobisisobutyronitrile,
2,2′-azobis(2-methylbutyronitrile),
1,1′-azobis(cyclohexane-1-carbonitrile),
2,2′-azobis(2,4-dimethylvaleronitrile),
2,2′-azobis(2,4-dimethyl-4-methoxyvaletonitrile),
dimethyl-2,2′-azobis(2-methyl propionate),
4,4′-azobis(4-cyanovaleric acid),
2,2′-azobis(2-hydroxymethylpropionitrile) and the like;
   organic peroxides such as tert-butyl hydroperoxide, benzoyl peroxide, tert-butyl peroxybenzoate, cumene hydroperoxide, diisopropyl peroxy dicarbonate, di-n-propyl peroxydicarbonate, tert-butyl peroxyneodecanoate, tert-butyl peroxypivalate, (3,5,5-trimethylhexanonyl) peroxide and the like; inorganic peroxides such as potassium persulfate, ammonium persulfate, hydrogen peroxide and the like.

Further, redox-based initiators using a heat-polymerization initiator and a reducing agent together can also be used as a polymerization initiator.

As the method of producing an acrylic resin of the present invention, a solution polymerization method is preferable.

As the method of producing an acrylic resin of the present invention by a solution polymerization method, there are listed, for example, a method in which the monomers (a) to (d), and if necessary a vinyl-based monomer different from any of the monomers (a) to (d), and an organic solvent are mixed, a heat-polymerization initiator is added under a nitrogen atmosphere, and the mixture is stirred for about 3 to 10 hours at usually about 40 to 90° C., preferably about 60 to 70° C., and other methods. The reaction may also be controlled by a method in which monomers and a heat-polymerization initiator used are added during the polymerization reaction, a method in which monomers and a heat-polymerization initiator used are dissolved in an organic solvent before addition thereof, and the like. Here, examples of the organic solvent used include aromatic hydrocarbons such as toluene, xylene and the like; esters such as ethyl acetate, butyl acetate and the like; aliphatic alcohols such as n-propyl alcohol, isopropyl alcohol and the like; ketones such as methyl ethyl ketone, methyl isobutyl ketone and the like.

The viscosity of an acrylic resin of the present invention is usually 100 Pa·s or less, preferably 50 Pa·s or less. When the viscosity of an acrylic resin is 100 Pa·s or less, even if the dimension of an optical film changes, the resulting adhesive layer varies following this dimension change, consequently, a difference between brightness of peripheral parts of a liquid crystal cell and brightness of central parts disappears, and light leakage and non-uniformity of color tend to be suppressed preferably. The viscosity of an acrylic resin means a viscosity at 25° C. of a solution prepared containing 30 wt % of the acrylic resin in ethyl acetate.

The molecular weight of an acrylic resin of the present invention is a weight-average molecular weight according to a light scattering method of gel permeation chromatography (GPC), and is usually 5×10⁵ or more, preferably 1×10⁶ or more. When the weight-average molecular weight is 5×10⁵ or more, adhesion under high temperature and high humidity increases, and peeling between an adhesive layer and a glass base plate tends to lower, further, a re-working property tends to be improved, preferably.

The acrylic resin of the present invention may be used as it is, for example as an adhesive, adhesive, paint, thickening agent and the like.

Of them, an adhesive obtained by compounding a cross-linking agent and/or silane-based compound in an acrylic resin composition of the present invention is preferable since it is excellent in durability and adhesion to an optical film and the like, and particularly, an adhesive obtained by compounding a cross-linking agent and silane-based compound in an acrylic resin of the present invention is suitable.

Here, the cross-linking agent has in the molecule two or more functional groups capable of cross-linking with a polar functional group, and specific examples thereof include isocyanate-based compounds, epoxy-based compounds, metal chelate-based compounds, aziridine-based compounds and the like.

Here, examples of the isocyanate-based compound include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethylxylylene diisocyanate, naphthalene diisocyanate, triphenylmethane triisocyanate, polymethylene polyphenyl isocyanate and the like. Further, adducts obtained by reacting polyols such as trimethylolpropane and the like with the above-mentioned isocyanate compounds can also be used.

Examples of the epoxy-based compound include bisphenol A type epoxy resin, ethylene glycol glycidyl ether, polyethylene glycol diglycidyl ether, glycerine diglycidyl ether, glycerine triglycidyl ether, 1,6-hexanediol diglycidyl ether, trimethylolpropane triglycidyl ether, diglycidylaniline, N,N,N′,N′-tetraglycidyl-m-xylenediamine, 1,3-bis (N,N′-diglycidylaminomethyl)cyclohexane and the like.

Examples of the metal chelate compound include compounds obtained by coordinating acetylacetone and ethyl acetoacetate on poly-valent metals such as aluminum, iron, copper, zinc, tin, titanium, nickel, antimony, magnesium, vanadium, chromium, zirconium and the like.

Examples of the aziridine-based compound include
N,N′-diphenylmethane-4,4′-bis(1-aziridine carboxide),
N,N′-toluene-2,4-bis(1-aziridine carboxamide),
triethylenemelamine, bisisophthaloyl-1-(2-methylaziridine),
tri-1-aziridinylphosphine oxide,
N,N′-hexamethylene-1,6-bis(1-aziridine carboxide),
trimethylolpropane-tri-B-aziridinyl propionate,
tetramethylolmethane-tri-β-aziridinyl propionate, and the like.

The cross-linking agent may be used singly or in combination of two or more.

The use amount of a cross-linking agent in an adhesive of the present invention is usually from about 0.005 to 5 parts by weight, preferably from about 0.01 to 3 parts by weight based on 100 parts by weight of an acrylic resin (solid content). When the amount of the cross-linking agent is 0.005 parts by weight or more, peeling between an adhesive layer and a glass base plate and a re-working property tend to be improved preferably, and when 5 parts by weight or less, a property of an adhesive layer to follow the dimension change of an optical film is excellent, consequently, light leakage and non-uniformity of color tend to lower, preferably.

Examples of the silane-based compound used in an adhesive of the present invention include vinyltrimethoxysilane, vinyltriethoxysilane, vinyltris(2-methoxyethoxy)silane,
N-(2-aminoethyl)-3-aminopropylmethyldimethoxysilane,
N-(2-aminoethyl)-3-aminopropyltrimethoxysilane,
3-aminopropyltriethoxysilane,
3-glycidoxypropyltrimethoxysilane,
3-glycidoxypropylmethyldimethoxysilane,
2-(3,4-epoxycyclohexyl)ethyltrimethoxysilane,
3-chloropropylmethyldimethoxysilane,
3-chloropropyltrimethoxysilane,
3-methacryloxypropyltrimethoxysilane,
3-mercaptopropyltrimethoxysilane and the like. The silane-based compound may be used singly or in admixture of two or more.

The use amount of the silane-based compound in an adhesive is usually from about 0.0001 to 10 parts by weight, preferably from 0.01 to 5 parts by weight based on 100 parts by weight of an acrylic resin. When the amount of a silane-based compound is 0.0001 part by weight or more, adhesion between an adhesive layer and a glass base plate is improved preferably. When the amount of a silane-based compound is 10 parts by weight or less, bleeding out of a silane-based compound from the adhesive layer tends to be suppressed to suppress cohesive failure of an adhesive layer, preferably.

The adhesive of the present invention comprises an acrylic resin, cross-linking agent and/or silane-based compound as described above, and additives such as a cross-linking catalyst, weather-resistant stabilizer, tackifier, plasticizer, softening agent, dye, pigment, inorganic filler and the like may be further compounded.

When a cross-linking catalyst and cross-linking agent are compounded in an adhesive of the present invention, an optical laminated film can be prepared by aging in a short period of time, and in an optical laminate containing this film, peeling between an adhesive layer and a glass base plate, and foaming in an adhesive layer are suppressed and a re-working property is excellent.

Here, examples of the cross-linking catalyst include amine-based compounds such as hexamethylenediamine, ethylenediamine, polyethyleneimine, hexamethylenetetramine, diethylenetriamine, triethylenetetramine, isophoronediamine, triethylenediamine, polyamino resins, melamine resins and the like.

Examples of the cross-linking agent include isocyanate-based compounds, epoxy-based compounds, metal chelate-based compounds, aziridine-based compounds and the like. As these compounds, the same compounds as described above are illstrated.

When an amine compound is used as a cross-linking catalyst, an isocyanate-based compound is suitable as a cross-linking agent.

The optical laminated film of the present invention is obtained by laminating the above-mentioned adhesive on both surfaces or one surface of an optical film.

As the method of producing an optical laminated film, there are listed, for example, a method in which an adhesive diluted in an organic solvent is applied on a release film, and heated at 60 to 120° C. for about 0.5 to 10 minutes to distill-off the organic solvent, to obtain an adhesive layer. Next, an optical film is pasted on the adhesive layer, then, the laminate is aged for about 5 to 20 days under an atmosphere of a temperature of 23° C. and a humidity of 50%, and when a cross-linking agent is contained, after sufficient reaction of the cross-linking agent, a release film is peeled to obtain an optical laminated film; a method in which, after an adhesive layer is obtained in the same manner as described above, laminates composed of two layers of the resulted release film and adhesive layer are combined in multiple layers so that the release films and adhesive layers are alternate, then, aged for about 5 to 20 days under an atmosphere of a temperature of 23° C. and a humidity of 50%, and when a cross-linking agent is contained, after sufficient reaction of the cross-linking agent, a release film is peeled, and an optical film is pasted instead of the release film, to obtain an optical laminated film; and other methods.

Here, the release film is a base material in forming an adhesive layer. The release film may also be a base material for protecting an adhesive layer from extraneous substances such as trash, dust and the like during aging or in preserving as an optical laminated film, in some cases. As specific examples of the release film, those obtained, for example, by using a film made of various resins such as polyethylene terephthalate, polybutylene terephthalate, polycarbonate, polyallylate and the like and performing a releasing treatment (silicone treatment and the like) on a connecting surface of this base material with an adhesive layer, are mentioned.

Here, the optical film used is a film having an optical property, and examples thereof include a polarizing film, phase retardation film and the like.

The polarizing film is an optical film having a function of emitting polarization against incidence light such as natural light and the like. Examples of the polarizing film include a straight line polarizing film absorbing straight line polarization on a vibration plane parallel to an optical axis and allowing permeation of straight light polarization having a vibration plane which is a vertical plane, a polarization separation film reflecting straight line polarization on a vibration plane parallel to an optical axis, an elliptic polarizing film obtained by laminating a polarizing film and a phase retardation film described later. As the specific examples of the polarizing film, those in which dichroic coloring matters such as iodine, dichroic dyes and the like are adsorbed and oriented in a polyvinyl alcohol film mono-axially drawn, and the like are listed.

The phase retardation film used is an optical film having mono-axial or di-axial optical anisotropy, and listed are stretched films obtained by stretching at about 1.01 to 6-fold a polymer film made of polyvinyl alcohol, polycarbonate, polyester, polyallylate, polyimide, polyolefin, polystyrene, polysulfone, polyether sulfone, polyvinylidene fluoride/polymethyl methacrylate, liquid crystal polyester, acetylcellulose, cyclic polyolefin, ethylene-vinyl acetate copolymer saponified material, polyvinyl chloride and the like, for example. Of them, polymer films obtained by mono-axial or bi-axial stretching of polycarbonate or polyvinyl alcohol are preferably used.

Examples of the phase retardation film include a mono-axial phase retardation film, wide field angle phase retardation film, low photo-elastic phase retardation film, temperature-compensated phase retardation film, LC film (rod-like liquid crystal twisted orientation), WV film (disc-like liquid crystal inclined orientation), NH film (rod-like liquid crystal inclined orientation), VAC film (complete bi-axial orientation type phase retardation film), new VAC film (bi-axial orientation type phase retardation film) and the like.

On an optical film used in the present invention, a protective film may be pasted, and an adhesive of the present invention may be laminated on the optical film carrying the protective film pasted.

Examples of the protective film include acrylic resin films made of acrylic resins different from the acrylic resin of the present invention, acetylcellulose-based films such as a cellulose tiacetate film and the like, polyester resin films, olefin resin films, polycarbonate resin films, polyether ether ketone resin films, polysulfone resin films and the like. In the protective film, ultraviolet absorbers such as a salicylate-based, compound, benzophenone-based compound, benzotriazole-based compound, triazine-based compound, cyanoacrylate-based compound, nickel complex salt-based compound and the like may be compounded. Among the protective films, acetylcellulosed-based films are suitably used.

The optical laminate of the present invention is obtained by laminating a glass base plate on an adhesive layer of an optical laminated film. Usually, an optical laminate can be produced by pasting an adhesive layer of an optical laminated film and a glass base plate. Here, examples of the glass base plate include a glass base plate of liquid crystal cell, non-glaring glass, glass for sunglasses, and the like. Of them, an optical laminate obtained by laminating an optical laminated film (upper plate polarization plate) on an upper glass base plate of a liquid crystal cell, and laminating another optical laminated film (lower plate polarization plate) on a lower glass base plate of a liquid crystal cell is preferable since it can be used as a liquid crystal display. As the material of a glass base plate, for example, soda lime glass, low-alkali glass, non-alkali glass and the like are listed.

With the optical laminate of the present invention, even after peeling of an optical laminate film having an adhesive layer from an optical laminate, fogging, paste remaining and the like scarcely occur on the surface of a glass base plate in contact with the adhesive layer, an optical laminated film having an adhesive layer can be easily pasted again on the glass base plate peeled, namely, a re-working property thereof is excellent.

The acrylic resin of the present invention can be used to produce an optical laminated film used in a liquid crystal cell in which light leakage is suppressed. The acrylic resin of the present invention is excellent in flexibility and shows excellent adhesion with an optical film and the like.

The acrylic resin of the present invention can be suitably used as an adhesive by compounding a hardening agent and/or silane-based compound. An optical laminated film obtained by laminating an optical film and the adhesive can be, for example, laminated on a glass base plate of a liquid crystal cell to produce an optical laminate. In such an optical laminate, the adhesive layer absorbs and relaxes stress derived from the dimension change of the optical film and glass base plate under heat and humidity conditions, therefore, local stress concentration is decreased, and peeling of the adhesive layer from the glass base plate is suppressed. Further, since optical defects caused by un-uniform stress distribution are prevented, when the glass base plate is a TN liquid crystal cell (TNT), light leakage is suppressed, and when the glass base plate is a STN liquid crystal cell, non-uniformity of color is suppressed. Furthermore, since a re-working property is excellent, even if an optical laminated film once laminated is peeled from the glass base plate of the optical laminate, paste remaining and fogging on the surface of the glass base plate after peeling are suppressed, and it can be again used as a glass base plate.

The acrylic resin of the present invention can be used for, for example, an adhesive, adhesive, paint, thickening agent and the like. An adhesive containing an acrylic resin of the present invention can be used suitably in an optical laminate such as a liquid crystal cell and the like.

### EXAMPLES

The present invention will be described further in detail based on examples, but it is needless to say that the scope of the invention is not limited to these examples at all.

In the examples, “parts” and “%” are by weight unless otherwise stated.

The content of solid components was measured according to a method of JIS K-5407. Specifically, an optional weight of adhesive solution was placed on a Petri dish, and dried in an explosion protection oven at 115° C. for 2 hours, then, the weight of remaining solid components was divided by the weight of the originally weighed solution.

The viscosity is a value measured by a Brook field viscometer at 25° C.

Measurement of the weight-average molecular weight by a light scattering method of GPC was conducted using a GPC apparatus equipped with a light scattering photometer and differential refractometer as a detector, under conditions of a sample concentration of 5 mg/ml, a sample introduction amount of 100 μml, a column temperature of 40° C. and a flow rate of 1 ml/min, and using tetrahydrofuran as an eluent.

<Production Example of Acrylic Resin>

### Polymerization Example 1

A mixed solution composed of 120 parts of butyl acrylate as a monomer (a), 2.3 parts of tripropylene glycol diacrylate as a monomer (b), 5.6 parts of N-vinyl-2-pyrrolidone as a monomer (c) and 1.5 parts of 4-hydroxybutyl acrylate as a monomer (d) was prepared. Separately, into a reactor equipped with a cooling tube, nitrogen introduction tube, thermometer and stirrer was charged 294 parts of ethyl acetate, air in the apparatus was purged with a nitrogen gas, then, the inner temperature was raised to 70° C. A solution prepared by dissolving 0.84 parts of azobisisobutyronitrile (hereinafter, referred to as AIBN) in 10 g of ethyl acetate was added to the reactor, then, the mixed solution prepared was dropped into the reactor over 3 hours while keeping the inner temperature at 69 to 71° C. Thereafter, the mixture was thermally insulated at 69 to 71° C. for 5 hours, to complete the reaction. An ethyl acetate solution containing an acrylic resin having a weight-average molecular weight according to a light scattering method of GPC of about 1330000 and having a solid content of 29.9% was obtained. The content of solid components in the solution was regulated to 30%, to find a viscosity of 142 mPa·s.

### Polymerization Example 2

A mixed solution composed of 120 parts of butyl acrylate as a monomer (a), 2.3 parts of tripropylene glycol diacrylate as a monomer (b), 5.6 parts of N-vinyl-2-pyrrolidone as a monomer (c) and 0.7 parts of acrylic acid as a monomer (d) was prepared. Separately, into the same reactor as in Polymerization Example 1 was charged 292 parts of ethyl acetate, air in the apparatus was purged with a nitrogen gas, then, the inner temperature was raised to 70° C. A solution prepared by dissolving 0.84 parts of AIBN in 10 g of ethyl acetate was added to the reactor, then, the mixed solution prepared was dropped into the reactor over 3 hours while keeping the inner temperature at 69 to 71° C. Thereafter, the mixture was thermally insulated at 69 to 71° C. for 5 hours, to complete the reaction. An ethyl acetate solution containing an acrylic resin having a weight-average molecular weight according to a light scattering method of GPC of about 1730000 and having a solid content of 29.2% was obtained. The content of solid components in the solution was regulated to 30%, to find a viscosity of 182 mPa·s.

### Polymerization Example 3

A mixed solution composed of 120 parts of butyl acrylate as a monomer (a), 2.3 parts of tripropylene glycol diacrylate as a monomer (b), 5.6 parts of N-vinyl-2-pyrrolidone as a monomer (c) and 1.4 parts of N,N-dimethylaminoethyl acrylate as a monomer (d) was prepared. Separately, into the same reactor as in Polymerization Example 1 was charged 294 parts of ethyl acetate, air in the apparatus was purged with a nitrogen gas, then, the inner temperature was raised to 70° C. A solution prepared by dissolving 0.84 parts of AIBN in 10 g of ethyl acetate was added to the reactor, then, the mixed solution prepared was dropped into the reactor over 3 hours while keeping the inner temperature at 69 to 71° C. Thereafter, the mixture was thermally insulated at 69 to 71° C. for 5 hours, to complete the reaction. An ethyl acetate solution containing an acrylic resin having a weight-average molecular weight according to a light scattering method of GPC of about 1600000 and having a solid content of 29.2% was obtained. The content of solid components in the solution was regulated to 30%, to find a viscosity of 98 mPa·s.

### Polymerization Example 4

A mixed solution composed of 80 parts of butyl acrylate as a monomer (a), 3.7 parts of N-vinyl-2-pyrrolidone as a monomer (c), 0.97 parts of 4-hydroxybutyl acrylate as a monomer (d) and 0.7 parts of divinylbenzene was prepared. Separately, into the same reactor as in Polymerization Example 1 was charged 190 parts of ethyl acetate, air in the apparatus was purged with a nitrogen gas, then, the inner temperature was raised to 70° C. A solution prepared by dissolving 0.55 parts of AIBN in 10 g of ethyl acetate was added to the reactor, then, the mixed solution prepared was dropped into the reactor over 3 hours while keeping the inner temperature at 69 to 71° C. Thereafter, the mixture was thermally insulated at 69 to 71° C. for 5 hours, to complete the reaction. An ethyl acetate solution containing an acrylic resin having a weight-average molecular weight according to a light scattering method of GPC of about 410000 and having a solid content of 31.2% was obtained. The content of solid components in the solution was regulated to 30%, to find a viscosity of 122 mPa·s.

### Polymerization Example 5

A mixed solution composed of 72 parts of butyl acrylate as a monomer (a), 1.3 parts of tripropylene glycol diacrylate as a monomer (b) and 0.82 parts of 4-hydroxybutyl acrylate as a monomer (d) was prepared. Separately, into the same reactor as in Polymerization Example 1 was charged 164 parts of ethyl acetate, air in the apparatus was purged with a nitrogen gas, then, the inner temperature was raised to 70° C. A solution prepared by dissolving 0.52 parts of AIBN in 10 g of ethyl acetate was added to the reactor, then, the mixed solution prepared was dropped into the reactor over 3 hours while keeping the inner temperature at 69 to 71° C. Thereafter, the mixture was thermally insulated at 69 to 71° C. for 5 hours, to complete the reaction. An ethyl acetate solution containing an acrylic resin having a weight-average molecular weight according to a light scattering method of GPC of about 800000 and having a solid content of 30.0% was obtained.

### Polymerization Example 6

93.7 parts of butyl acrylate as a monomer (a), 4.3 parts of N-vinylpyrrolidone as a monomer (c), 2.0 parts of 4-hydroxybutyl acrylate as a monomer (d) and 96.0 parts of ethyl acetate were used, and air in the apparatus was purged with a nitrogen gas to give a no-oxygen containing atmosphere, then, the inner temperature was raised to 55° C. A solution prepared by dissolving 0.018 parts of 2,2′-azobis(2,4-dimethylvaleronitrile) in 4 parts of ethyl acetate was all added, then, the mixture was thermally insulated for 3 hours while keeping the inner temperature at 54 to 56° C. At this stage, the concentration of unreacted monomers was 50%. Thereafter, ethyl acetate was added every 3 hours so that the total concentration of the monomers (a), (c) and (d) charged decreased by 5%, and from a point when the concentration of unreacted monomers reached 15%, the mixture was thermally insulated for 3 hours, to complete the reaction. The resulted acrylic resin solution had a solid content of 19.4% and a viscosity of 51600 mPa·s. The weight-average molecular weight according to a light scattering method of GPC was about 3770000.

### Example 1

<Adhesive Production Example>

To 100 parts of solid components in the ethyl acetate solution of an acrylic resin obtained in the above-mentioned Polymerization Example 1 was mixed a polyisocyanate-based compound as a cross-linking agent (trade name: Coronate L, manufactured by Nippon Polyurethane, solid content: 0.5 parts) and γ-glycidoxypropyl trimethoxysilane (0.2 parts) as a silane-based compound.

<Production Example of Optical Laminated Film>

The resulted adhesive was applied, using an applicator, on a releasing-treated surface of a polyethylene terephthalate film (manufactured by Rintech, trade name: PET 3811) which had been subjected to releasing treatment so that the thickness after drying was 25 μm, dried at 90° C. for 1 minute, to obtain an adhesive in the form of sheet. Then, a polarizing film (film having a three-layer structure obtained by adsorbing iodine into polyvinyl alcohol and stretching this and sandwiching this on both surfaces thereof by triacetylcellulose-based base plate films) was used as an optical film, and a surface having the adhesive obtained above was pasted on the optical film by a laminator, then, aged under conditions of a temperature of 40° C. and a humidity of 20% for 14 days, to obtain an optical laminated film having an adhesive layer.

<Production Example of Optical Laminate>

A surface of the adhesive layer of the optical laminated film was adhered on both surfaces of a glass base plate for liquid crystal cell (manufactured by Corning, 1737) so as to give Cross Nicol condition. This was preserved under 80° C. and dry condition for 96 hours (condition 1) and preserved under 60° C. and 90% RH for 96 hours (condition 2), and durability and light leakage-generated state of the optical laminate after preservation were observed visually. The results are classified as described below and summarized in Table 1.

<Durability>

Evaluation of durability was conducted according to the following four stages.
\mathring{◯}: no change in appearance such as floating, peeling, foaming and the like
◯: little change in appearance such as floating, peeling, foaming and the like
Δ: slight change in appearance such as floating, peeling, foaming and the like
X: remarkable change in appearance such as floating, peeling, foaming and the like
   <Light Leakage-Generated State>

Evaluation of state of generation of light leakage was conducted according to the following four stages.
\mathring{◯}: no light leakage
◯: little light leakage
Δ: slight light leakage
X: remarkable light leakage
   <Re-Working Property>

Evaluation of the re-working property was conducted as described below. First, the above-mentioned optical laminated film was cut into a specimen of 25 mm×150 mm. Then, this specimen was laminated on a glass base plate for liquid crystal cell (manufactured by Nippon Sheet Glass Co., Ltd., soda lime glass) using a pasting apparatus (Lamipacker, manufactured by Fuji Plastic Machine K.K.), and treated in an autoclave under 50° C., 5 kg/cm² (490.3 kPa) for 20 minutes, to obtain an optical laminate for peeling test. Subsequently, the optical laminate for peeling test was preserved in an atmosphere of 23° C. and 50% RH for 720 hours, then, this pasted specimen was peeled toward 180° direction at a rate of 300 mm/ml in an atmosphere of 23° C. and 50% RH, and the state of the surface of the glass plate was observed. The results were classified as described below and summarized in Table 1.

Evaluation of re-working property was conducted according to the following four stages depending on the state of the surface of a glass plate.
\mathring{◯}: no fogging and past remaining on the surface of glass plate
◯: little fogging and the like on the surface of glass plate
Δ: fogging and the like on the surface of glass plate
X: paste remaining on the surface of glass plate

### Examples 2 to 6 and Comparative Examples 1 to 3

Adhesives and optical laminates were produced in the same manner as in Example 1 except that addition parts of the acrylic resins and cross-linking agents used were changed. The evaluation results of the resulted acrylic resins and optical laminates were summarized in Table 1. In Comparative Examples 1, 2 and 3, adhesives and optical laminates were produced in the same manner as in Example 1 except that the acrylic resins of Polymerization Examples 4, 5 and 6 were used respectively. The evaluation results of the resulted acrylic resins and optical laminates were summarized in Table 1.

TABLE 1

| | | Example | | | | | | Comparative example | | |
|---|---|---|---|---|---|---|---|---|---|---|
| | | 1 | 2 | 3 | 4 | 5 | 6 | 1 | 2 | 3 |
| | | Polymerization example | | | | | | | | |
| Acrylic resin | | 1 | 1 | 2 | 2 | 3 | 3 | 4 | 5 | 6 |
| Production | (a) | 120 | 120 | 120 | 120 | 120 | 120 | 80 | 72 | 93.7 |
| of acrylic | (b) | 2.3 | 2.3 | 2.3 | 2.3 | 2.3 | 2.3 | 0 | 1.3 | 0 |
| resin (parts) | (c) | 5.6 | 5.6 | 5.6 | 5.6 | 5.6 | 5.6 | 3.7 | 0 | 4.3 |
| | (d) | 1.5 | 1.5 | 0.7 | 0.7 | 1.4 | 1.4 | 0.97 | 0.82 | 2.0 |
| | Divinylbenzene | 0 | 0 | 0 | 0 | 0 | 0 | 0.66 | 0 | 0 |
| Acrylic | Viscosity | 142 | 142 | 182 | 182 | 98 | 98 | 122 | 109 | 51600 |
| resin | (mPa · s)*¹ | | | | | | | | | |
| | Molecular weight | 142 | 142 | 173 | 173 | 160 | 160 | 41 | 80 | 377 |
| | (×10000) | | | | | | | | | |
| Parts of cross-linking agent | | 0.5 | 0.8 | 4 | 6 | 0.5 | 0.8 | 0.8 | 0.8 | 0.13 |
| added (parts) | | | | | | | | | | |
| Condition 1 | Durability | ◯ | ⊚ | ⊚ | ⊚ | ◯ | ⊚ | X | Δ | Δ |
| | Light leakage | ⊚ | ◯ | ⊚ | ◯ | ⊚ | ⊚ | Δ | X | Δ |
| | property | | | | | | | | | |
| Condition 2 | Durability | ◯ | ⊚ | ◯ | ⊚ | ◯ | ◯ | X | ◯ | Δ |
| Re-working | Past remaining | ⊚ | ⊚ | ◯ | ⊚ | ◯ | ⊚ | X | Δ | Δ |
| property | property | | | | | | | | | |

*¹viscosity at 25° C. and a resin concentration of 30 wt %

1. An acrylic resin obtained by copolymerizing the following (a), (b), (c) and (d):
(a): a (meth)acrylate of the formula (1) 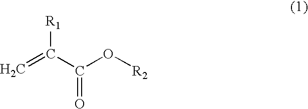
(wherein, R₁ represents a hydrogen atom or methyl group, R₂ represents an alkyl group having 1 to 14 carbon atoms or an aralkyl group having 1 to 14 carbon atoms, and a hydrogen atom in the alkyl group R₂ or a hydrogen atom in the aralkyl group R₂ may be substituted with an alkoxy group having 1 to 10 carbon atoms),
(b): a monomer containing at least two (meth)acryloyl groups of the general formula (2) in the molecule 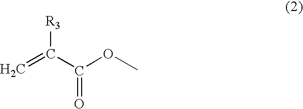
(wherein, R₃ represents a hydrogen atom or methyl group),
(c): a monomer containing a heterocycle and one olefinic double bond in the molecule, and
(d): a monomer different from (a), (b) and (c), and containing one olefinic double bond and at least one polar functional group selected from the group consisting of a carboxyl group, hydroxyl group, amide group, amino group, epoxy group, aldehyde group and isocyanate group in the molecule.

2. The acrylic resin according to claim 1, wherein the monomer (c) is at least one monomer selected from the group consisting of N-vinylpyrrolidone, acryloylmorpholine and vinylcaprolactam.

3. An adhesive comprising the acrylic resin according to claim 1, and a cross-linking agent and/or silane-based compound.

4. An optical laminated film having the adhesive according to claim 3 laminated on both surfaces or one surface of an optical film.

5. The optical laminated film according to claim 4, wherein the optical film is a polarizing film and/or phase retardation film.

6. The optical laminated film according to claim 4, wherein the optical film is an optical film further having an acetylcellulose-based film as a protective film.

7. The optical laminated film according to claim 4, wherein a release film is further laminated on the adhesive layer of the optical laminated film.

8. An optical laminate obtained by laminating a glass base material on the adhesive layer of the optical laminated film according to claim 4.

9. An optical laminate obtained by peeling the release film from the optical laminated film according to claim 7, then, laminating a glass base material on the adhesive layer of the optical laminated film.
